(19) United States
(12) Patent Application Publication
(10) Pub. No.: US 2005/0079275 A1
(43) Pub. Date: Apr. 14, 2005

(54) New silage making method and apparatus

(76) Inventors: Asbjorn Nes, Veitastrong (NO); Leon Van Amstell, Geldrop (NL)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/498,401

(22) PCT Filed: Dec. 9, 2002
(86) PCT No.: PCT/GB02/05578

(30) Foreign Application Priority Data
Dec. 10, 2001 (NO) 2001/6020

(51) Int. Cl. B05D 3/02

(52) U.S. Cl. 427/4; 427/372.2; 118/300

(57) ABSTRACT

A method and apparatus for ensilage of a fodder mass in which the fodder mass (5) is compressed in a confined space so as to expel air from the mass and with at least part of the outer surface of the mass remaining exposed, and applying a gel coating (1) (preferably a foam coating) to the exposed outer surface of the mass which cures or sets to form a substantially air and water-tight covering of the fodder mass so that fermentation of the fodder mass can take place to form silage.

The invention is concerned generally with the ensilage of a fodder mass, and in particular to provide a new and improved method for preserving fodder as well as machines to perform such methods.

It is well known to preserve fodder by ensilage, in which the fodder is preferably compacted and thereafter airtight enclosed. After a certain time lactic acid bacteria present will produce lactic acid to lower the ph value of the fodder. Due to the ph drop, all other bacterial activity (rotting) is stopped and a stable condition in the enclosed fodder is created. This method is well known for fresh grass and wilted grass, chopped maize plants, but is also known for other fodder, such as beet leaves, or potato chips or beet waste. The grass or wilted grass can be compacted by means of a square or round baler, or is compacted in a place of storage (pit/clamp) by its own weight and/or by driving over with a tractor or loader. Another well known way of storing silage is in a tower silo. After the compaction, an airtight enclosure is formed over a silage pit with a plastics sheet. For round or square bales, stretched plastics film is completely wrapped around the bale.

An alternative method with bales is piling them to form a stack, and covering the stack with a plastics sheet. When silage is required for feeding farm animals, the clamp is partly opened and the required silage is taken out. The clamp is left partly open, ready for the next discharge, and therefore oxygen can penetrate into the clamp, so that a minimum speed of discharge is needed to prevent moult, or other deterioration in the silage. Before taking silage from wrapped bales, the film first has to be stripped from the bale.

Storing fodder by ensilage has been proved to be a reliable and cost effective way of conserving fodder. However, the plastics used for making the silage airtight is non-degradable and therefore needs to be collected. If re-used, contamination with sand and silage gives a big problem.

According to the invention, there is provided a method of ensilage of a fodder mass as defined in claim 1.

Preferred developments of the method are set out in dependent claims 2 to 32.

According to a further aspect of the invention there is provided apparatus as defined in claim 33.

Preferred features of the apparatus are set out in dependent claims 34 to 36.

Preferred examples of the invention will now be described in detail, with reference to the accompanying drawings, in which:

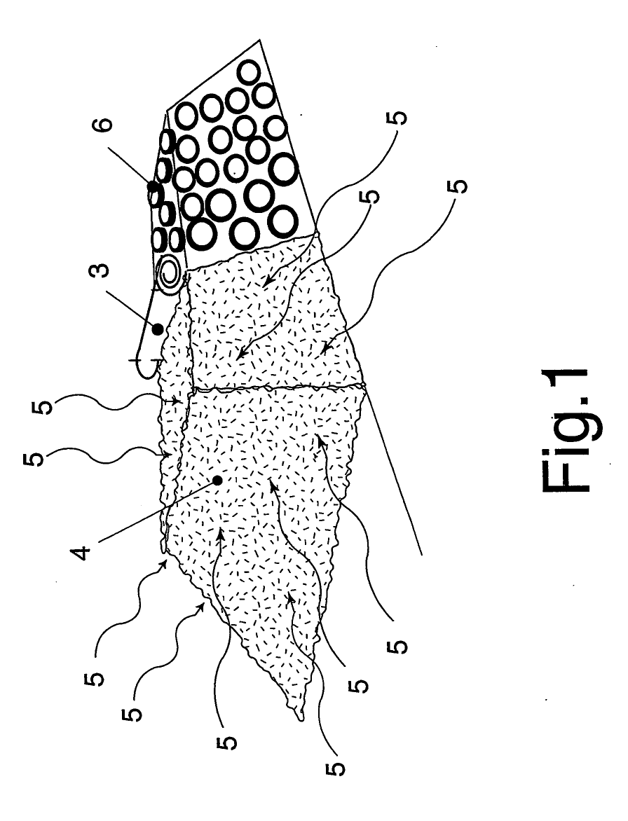

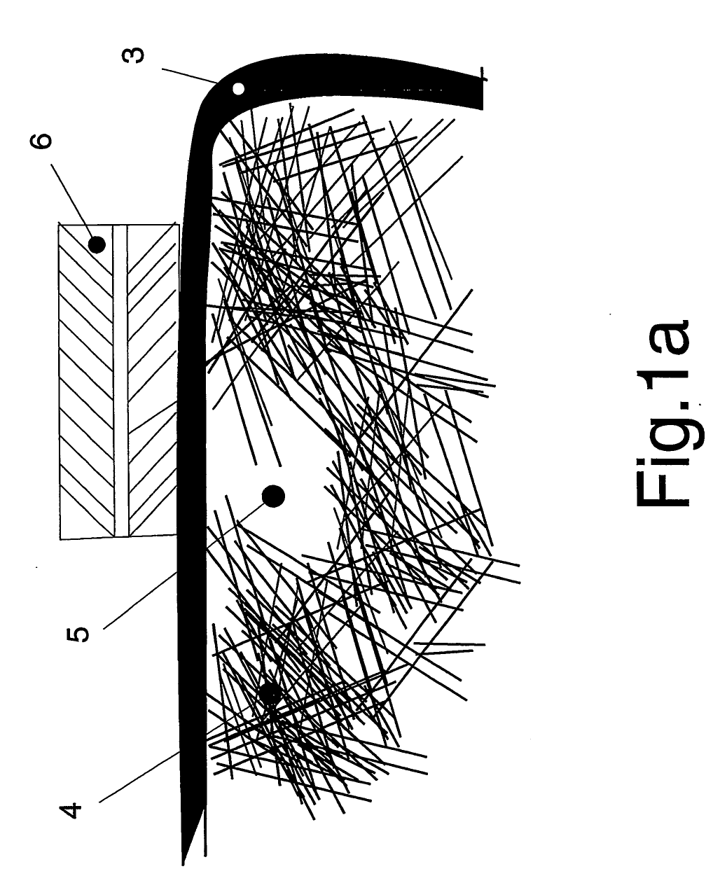

FIG. 1 is a perspective illustration of a conventional silage clamp, in which a compressed fodder mass is confined in a trench or walled enclosure (which is opened for discharge of the fodder after fermentation), and a plastics sheet covers the exposed surfaces of the fodder mass so as to exclude air and water and allow fermentation to take place;

FIG. 1a is a detail of FIG. 1, showing how it is necessary to hold down the plastics sheet with one or more external weights;

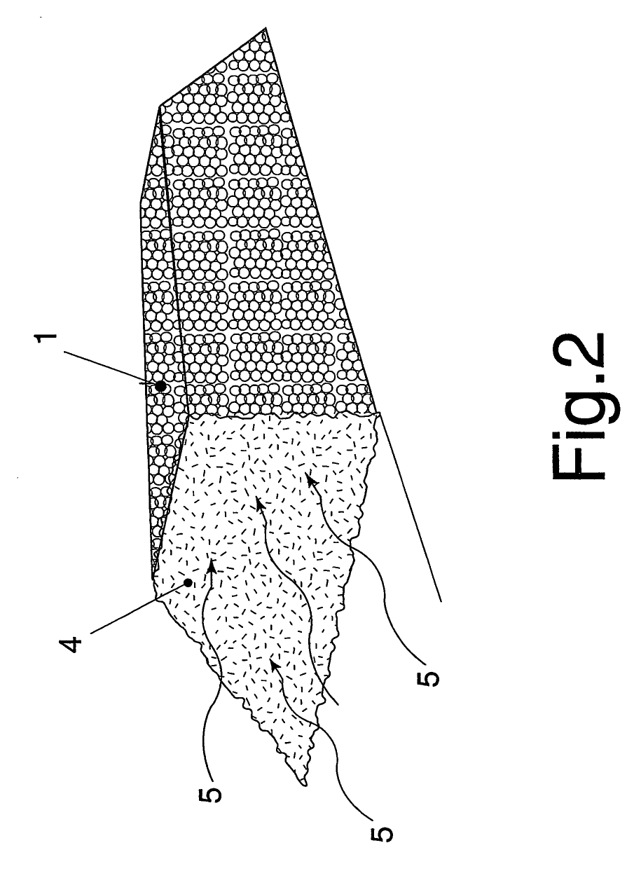

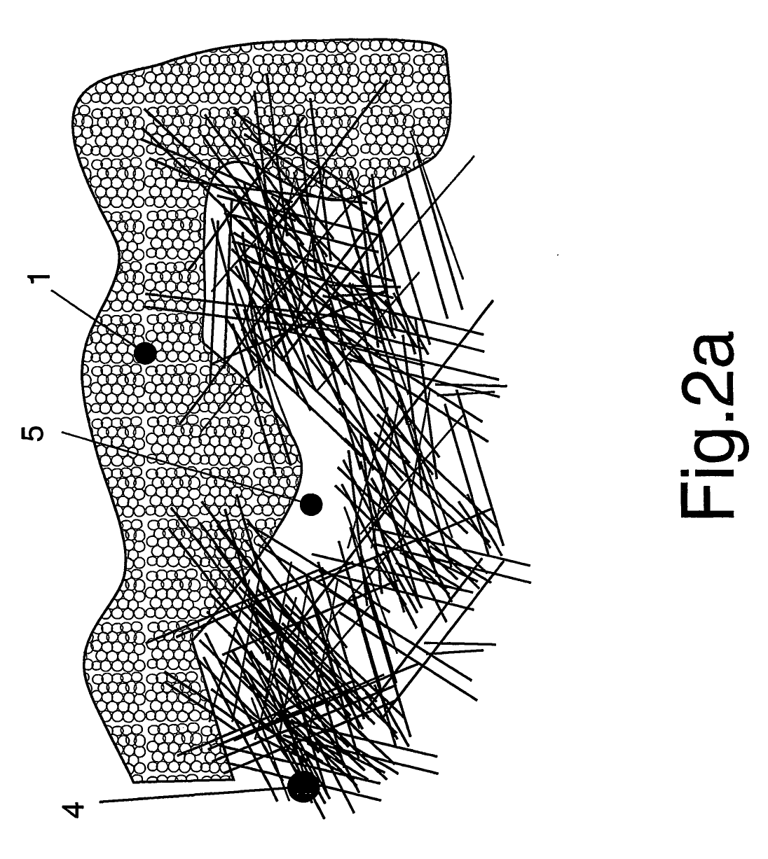

FIG. 2 is a view, similar to FIG. 1, of a first example of the invention, in which the exposed surfaces of the fodder mass are coated with a curable or settable gel coating which forms a protective air and water-tight foamed covering (also opened for discharge of the fodder after fermentation);

FIG. 2a is a detail illustration of part of FIG. 2, showing diagrammatically how outwardly projecting elements of the fodder mass e.g. stem material, become embedded in the foamed covering (this embedding in the foamed cover layer may also arise in subsequent examples of the invention described below with reference to the further figures of drawings);

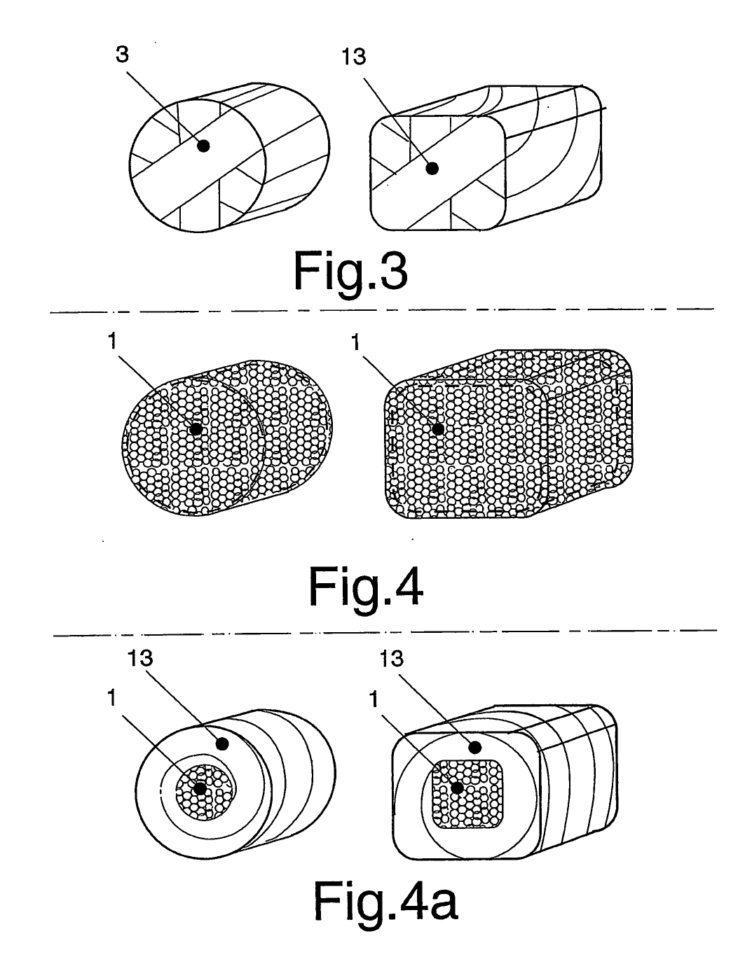

FIG. 3 is a diagrammatic illustration of conventional wrapping of a cylindrical and a square bale of compressed fodder e.g. partly wilted grass;

FIG. 4 illustrates another example of the invention, in which a cylindrical bale and a square bale are covered completely by a subsequently applied foamable gel coating;

FIG. 4a illustrates a modification of the example of FIG. 4, in which there is combined gel coating and film coverage of the bale;

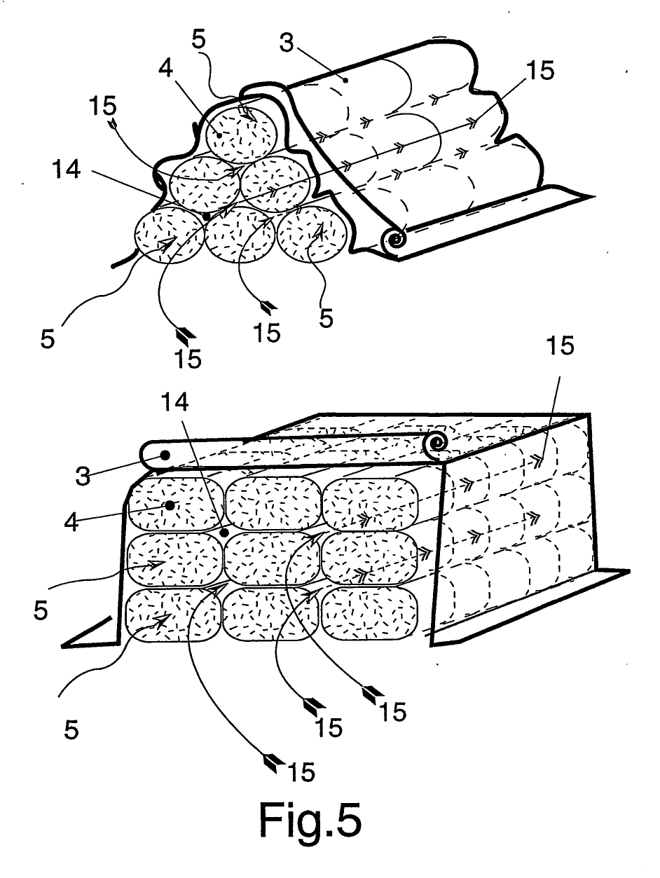

FIG. 5 illustrates conventional formation of stacks of cylindrical and square bales, which are covered with air and water-tight plastics sheets;

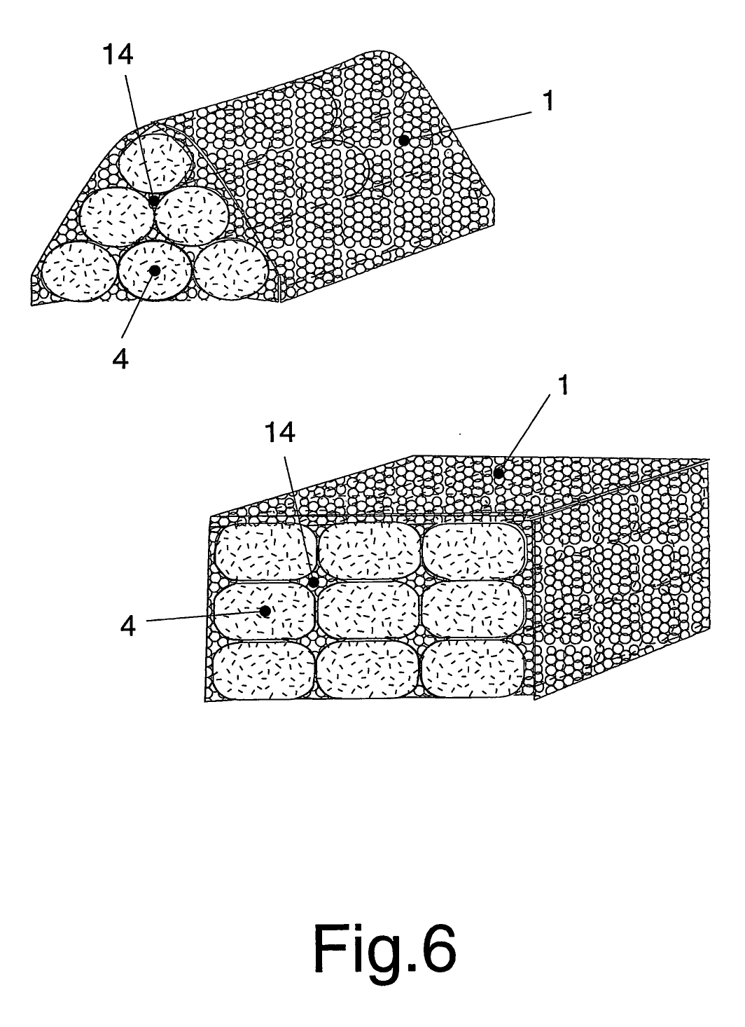

FIG. 6 illustrates a further example of the invention, in which the exposed surfaces of the stacks are covered with a foamed gel coating.

### EXAMPLE 1

### (Silage Clamp)

Referring now to FIG. 1 of the drawings, this shows a conventional silage clamp in which fodder is collected from the field and put into e.g. a trench silo (clamp or pit) by means of a loader. While bringing the fodder into the silo, the fodder is instantly compressed by riding over the fodder with the loader (to expel air from the fodder). When all the fodder has been put into the silo to form a compressed fodder mass 4, the silo is made airtight by means of putting a plastics sheet 3 over the top and the sides of the fodder mass. The sheet 3 is stabilised by putting on sand or heavy articles 6 so the wind will not get a grip on it. Also, the top layer of the fodder is compressed by this sand. The sides are made airtight to the ground by digging them into the ground.

Over a period of time, the fodder mass 4 ferments to form silage.

FIG. 1a is a detail showing how a large and heavy mass 6 is required to hold down the sheet 3 on the fodder mass 4. Reference 5 shows how external air can gain access to the fodder mass 4 when the sheet 3 is partly removed.

Referring now to FIGS. 2 and 2a, an example according to the invention will now be described. Thus, instead of making the trench silo airtight by means of a plastic sheet (as per FIG. 1), the silo is made airtight by applying a gel coating 1 to the exposed surfaces of the fodder mass 4, and in which the gel is preferably a foamed gel.

An advantage to using the gel is that it is easier to apply on the silo than the plastics sheet 3. Advantage of using a foaming gel is that less gel material is needed, because the foam will bridge the gaps or interstices between the fodder elements. Also, upon opening the clamp, the gel does not have to be removed from the silo because it will preferably be made of a material which can be safely eaten by animals.

When the pit is opened, the gel sticks tightly to the silo so that only the opened side of the pit will be penetrated with oxygen 5, and any possible moulting will only start from there. When a sheet is used (as in FIG. 1), it needs to be removed before taking away the silage for feeding to the animals, and moulting will start also on the surface where the sheet is taken away. When adding a second load of fodder after closing the pit, the plastics sheet also has to be removed and oxygen can again enter the pit. When applying an edible gel (in the example of the invention), the second load can be put on top of the sealed first load, so that no other oxygen can enter into the first load.

### EXAMPLE 2

### (Wrapped Bales)

Referring to FIG. 3, conventional wrapping of cylindrical and square bales is shown, in which stretch-film wrapping 13 is applied to the exposed surfaces of the bales.

The fodder is collected from the field and instantaneously compressed to form a round or square bale. After the bale has been compressed, its surface is wrapped with a so-called stretch film.

This wrapping can be done on the compressing machine (an integrated baler/wrapper), or on a separate machine, a so-called wrapper. The wrapped bales are stored on the field, or near the farm. When the silage needs to be fed to the animals, the film wrapping 13 is removed from the bale and the silage can be fed. Removing the film from the bale is a time consuming exercise, and of course also the removed film has to be disposed of safely.

Referring to FIG. 4, another example according to the invention will be described, in which a gel coating 1 is applied to the bales. Thus, instead of using a stretch film (as in FIG. 3), a (foam) gel coating 1 is applied onto the whole surface of the bale. The advantage is that the stretch film sheet of FIG. 3 does not have to be removed from the bale when the silage is being fed to the animals. The gel coating 1 can be applied in situ on the baler (before discharge of the bale); directly after discharge of the bale; or with a special device before or after transportation to the place of storage.

An alternative (in accordance with the invention) is the use of both film (preferably edible) and also a gel coating. This is shown in FIG. 4a, and the advantage is that the surface of the bale that is in contact with the ground (or the transporting equipment) is covered with the film wrapping sheet 13, and the other parts are covered with a gel coating 1. The sheet 13 has better instant mechanical properties, and so will not be damaged so quickly, and the gel coating has the advantages that it can be applied on areas of the surface which are difficult to reach. Also, the gel coating could be applied on the same surface with the film, and preferably with an edible film e.g. paper for better airtightness.

Although not shown in detail, examples of apparatus according to the invention will now be described. In particular, there is provided an apparatus for forming a compressed bale of a fodder mass, and which comprises: a bale-forming chamber; means for feeding a fodder mass to the chamber; means for binding the compressed bale to hold its shape, preferably by applying a netting layer (or binding with twine) to enclose at least part of the outer surface of a bale, after formation in the chamber; and means for applying a coating to the outer surface of the bale, such coating being of such a nature as to set and form a substantially airtight and watertight covering on the bale.

Preferably, means for applying the coating comprises spray jet nozzles arranged to apply the coating in jet form (preferably a gel coating, and especially a foamed gel) to the outer surface of the bale.

The jet nozzles may be arranged to apply the coating to the outer surface of the bale during, or after the binding of the bale.

Conveniently, the jet nozzles are mounted on the apparatus adjacent to the bale forming chamber (or channel), and are arranged to direct the gel coating onto the outer surface of the bale, and to penetrate the outer surface, whereby upon setting or curing, the coating forms a covering for the entire outer surface of the bale, and which also partly anchors itself into the outer surface of the bale thereby to contribute also to the maintenance of the shape of the bale.

### EXAMPLE 3

### (Making a Stack of Bales)

Referring now to FIG. 5, this shows a conventional way of covering stacks of bales with air and water-tight sheets, so that fermentation can take place to form silage.

The fodder is collected from the field and compressed into round or square bales 4 of the fodder. The bales are transported to the place where they are stored. There they are piled onto each other to form a stack (pile). The pile is covered with a sheet 3 to make the whole pile airtight, and which then ferments or matures to form a silage mass. FIG. 5 shows a rectangular stack formed from square bales, and also a generally triangular stack formed from round bales, and both opened up to allow removal of fermented fodder, and whereby atmospheric oxygen 5 gains access to the interior of the stack.

Also, opening up the stack will expose the gaps 14 (between adjacent bales 4 in the stack) to contact with atmospheric oxygen 15 throughout the interior of the stack, which is clearly disadvantageous.

Referring now to FIG. 6, this shows the exposed surfaces of the stacks covered with a gel coating 1, according to a further example of the invention. Thus, instead of covering the pile with a sheet 3, the stack is made airtight by applying a gel coating on the surface of the stack. The advantage is that the sheet does not have to be removed from the stack, when the silage is fed to the animals and the gel coating is easy to apply, especially on the vertical surfaces.

Also gel could be used to fill the gaps between the bales in the stack, which gives the advantage that when the stack is opened for feeding, the oxygen 15 cannot penetrate into the stack and start the moulting at the opposite side of the opening of the stack.

Another application of the gel coating is for using the gel as a temporary cover when the feeding of the silage has started. The needed amount of silage is taken out of the clamp or bale, and the opened surface is closed again with the gel coating, to prevent oxygen to enter the pit. This is an advantage, especially when small quantities of silage are required and the weather circumstances for moulting are good (warm weather).

Applying the Gel on the Clamp, Stack or Bale

The gel will be applied on the surface as a liquid.

The gel could be applied by pouring the liquid gel/foam onto the silage. By gravity action, it will dispense over the surface, and together with the viscosity and its adhesiveness, it will form a layer over, and partly integrate with the silage. After a certain time, the liquid will become solid by curing/setting/gelling and will form an airtight film. The curing /setting/gelling could be initiated by a catalyst or by lowering of temperature when exposed to the normal ambient temperature outside (gelatin). The film will be at least airtight. For better integration with the top layer of the silage, the gel could also be rubbed onto the silage.

Also the gel/foam could be sprayed under pressure with a nozzle onto the silage, on which it will stick. By spraying, an equal coverage of the film over the silage could be easily realised. The device for pouring on the gel/foam or for spraying or rubbing could be hand held or could be attached to devices for loading and/or compacting the clamp or to the transport/stacking devices for bales. The advantage is that after that the clamp or stack or parts of that are formed, the coverage can be done immediately. Especially when stacks are formed of bales, the advantage of having a dispensing device on the stacking device is a great advantage since the gel coating can be applied like mortar in a brick wall when stacking the bales onto each other. This is to fill-up the gaps or holes through which oxygen could penetrate after opening the stack at one side.

Integration with a baler could be realised by injecting the gel through holes in the bale forming chamber (a round baler) or press channel (a rectangular baler).

Physical Properties of the Gel

The gel should be of an edible type, since it integrates with the outer layer of the silage and can not be removed. It does not need to be nutritious, but this could well be an advantage. The gel is preferably a liquid gel of the type described in WO98/12239. Alternatively, all gels on an aqueous basis or non-aqueous basis, could be applicable. The gel possibly could contain additives to prevent moult, support the non-permeability for oxygen of the gel, and to add better taste or nutritious value to the gel. The gel additives can be in solid or liquid form, provided that they allow the gel, when set or cured to form a more or less solid airtight (and preferably also watertight) cover layer or coating.

Preferably the gel is made as a foam. This is to: (1) make it better to stick to vertical surfaces; (2) give a thicker layer for the same amount of liquid, more economical in use; (3) less chance of non-covered silage area; (4) to let it bridge holes in the surface of the silage; (5) to fill-up gaps and holes in bale stacks more easily; and, (6) to give a more flexible multi-layer surface which is less “cracky”, better to chew.

The gel should be sticky with respect to the silage (or if applicable to the edible film when used, for example, as per FIG. 4a).

The expansion factor of the foam should be preferably more than 5. The making of the foam could be done by mixing the gel under pressure with a gas and thereafter letting it expand. This gas does preferably not contain oxygen. Also an under pressure liquefied gas (preferably CO² or N²O) could be mixed with the gel. After releasing the pressure in for instance a spray gun, the gel will be incorporated in a foaming form. If a catalyst is needed to cure/set the gel, this preferably could be added just before the expansion, but could also be done after the expansion of the foam by intensively mixing the foam with the catalyst.

1. A method of ensilage of a fodder mass and which comprises:
compressing the fodder mass in a confined space so as to expel as much air as possible from the mass and with at least part of the outer surface of the mass remaining exposed; and,
applying a coating to the exposed surface of the mass which cures or sets to form a substantially air tight covering of the fodder mass in the confined space.

2. A method according to claim 1, in which the confined space is defined in a silage clamp or pit.

3. A method according to claim 1, in which the confined space is defined in a silage tower.

4. A method according to claim 2, in which the silage clamp or pit is loaded with successive loads of fodder mass, and each load has its exposed surface covered by the coating, prior to a further load being applied alongside and/or above the already coated load.

5. A method according to claim 2, in which the silage clamp or pit is loaded with successive loads of fodder mass and, when filled, the exposed surface of the combined loads is covered by the coating.

6. A method according to claim 1, in which the fodder mass is compressed in a bale-forming chamber, or a bale-forming channel, to form a cylindrical or square bale, prior to application of the coating.

7. A method according to claim 1, in which the coating is a gel coating which subsequently cures or sets.

8. A method according to claim 7, in which the gel coating is a foam coating.

9. A method according to claim 8, in which the foamed coating includes AGT, of a gel type disclosed in WO98/12239.

10. A method according to claim 1, in which the coating is made of, or includes a material which is edible, or at least not harmful when consumed by farm animals.

11. A method according to claim 8, in which the gel foam is expanded without oxygen.

12. A method according to claim 7, in which additives are incorporated in the gel, to provide one or more of:
a) prevention of moult;
b) adds nutritional content;
c) improvement of taste;
d) improved air tightness.

13. A method according to claim 6, in which a number of bales are assembled to form a stack of bales, and the gaps between the bales are filled with the coating material.

14. A method according to claim 1, in which the coating is such a character that, when it cures or sets, it also provides a substantially watertight cover to the exposed surface of the mass.

15. A method according to claim 6, in which the coating applied to at least part of the outer exposed surface of the mass comprises a film layer and a layer of curable gel.

16. A method according to claim 15, in which the film is made of material which is edible to farm animals.

17. A method according to claim 14, in which the gel layer cures to form a watertight gel layer.

18. A method according to claim 1, in which the coating comprises a gel which is aqueous or non-aqueous based.

19. A method according to claim 1, in which the coating comprises a gel having a liquid or semi-liquid formulation, and which is transformable into a solid or semi-solid state by curing or setting, by a) provision of a catalyst and/or b) by lowering of the temperature.

20. A method of forming a substantially airtight coating on a compressed bale of a fodder mass e.g. partly wilted grass, said method comprising:
forming a compressed bale of fodder in a bale-forming chamber or channel;
applying a netting layer, or binding e.g. with twine to at least part of the outer surface of the bale in order to maintain the shape of the formed bale; and
applying a coating to the outer surface of the bale, such coating setting to form a substantially airtight covering on the bale.

21. A method according to claim 20, in which the coating is applied to the bale while it is still resident in the bale-forming chamber or channel.

22. A method according to claim 21, in which the coating is applied to the bale during the application of the netting layer, or twine to the bale.

23. A method according to claim 21, in which the coating is applied to the bale, after the completion of the application of the netting layer to the bale.

24. A method according to claim 20, in which the coating is applied to the bale after the net-layered or bound bale has been discharged from the bale-forming chamber or channel.

25. A method according to claim 20, in which a gel coating is applied to the bale by spraying.

26. A method according to claim 23, in which a gel coating is injected into the bale-forming chamber or channel.

27. A method according to claim 21, in which the coating is a foamed coating which is applied to the bale so as to cover the exposed outer surface of the bale, and also to bridge the gaps between adjacent components of the fodder mass at or near the surface.

28. A method according to claim 21, in which the coating is a gel coating made of AGT of the type disclosed in WO98/12239.

29. A method according to claim 21, in which the bale is formed of hay, or partly wilted grass.

30. A method according claim 6, in which a bale handling and/or transportation device is provided with a spraying device for applying a gel coating to the outer surface of the bale.

31. A method according to claim 1, in which a gel coating is applied to the outer surface of the fodder mass by spraying, and preferably by a hand held spraying device, or by a gel-application machine.

32. A method according to claim 1, in which a fodder mass is partly coated with a film and partly with a gel coating.

33. An apparatus for forming a compressed bale of a fodder mass and comprising:
a bale-forming chamber or channel;
means for feeding a fodder mass to the chamber or channel;
means for applying a netting layer, or binding to enclosed at least part of the outer surface of a bale, after formation of the bale; and
means for applying a coating to the outer surface of the bale, said coating being of such a nature as to set and form a substantially airtight covering on the bale.

34. Apparatus according to claim 33, in which said means for applying the coating comprises spray jet nozzles arranged to apply the coating in jet form to the outer surface of the bale.

35. Apparatus according to claim 34, in which the jet nozzles are arranged to apply the coating to the outer surface of the bale during, or after the application of the netting layer, or binding to the bale.

36. Apparatus according to claim 34, in which the jet nozzles are mounted on the apparatus adjacent to the bale-forming chamber or channel, and are arranged to direct the coating onto the outer surface of the bale, and to penetrate the outer surface, whereby upon setting or curing, the coating forms a covering for the entire outer surface of the bale, and which also partly anchors itself into the outer surface of the bale, thereby to contribute also to the maintenance of the shape of the bale.
